(19) United States
(12) Patent Application Publication
(10) Pub. No.: US 2018/0012171 A1
(43) Pub. Date: Jan. 11, 2018

(54) ON-DEMAND RESOURCE ALLOCATION

(71) Applicant: Elie Massabki, San Carlos, CA (US)

(72) Inventor: Elie Massabki, San Carlos, CA (US)

(21) Appl. No.: 15/635,162

(22) Filed: Jun. 27, 2017

Related U.S. Application Data
(60) Provisional application No. 62/358,557, filed on Jul. 5, 2016.

(51) Int. Cl. G06Q 10/06; G06Q 10/10

(52) U.S. Cl. CPC G06Q 10/063112; G06Q 10/1053

(57) ABSTRACT

Disclosed apparatus, systems and methods may provide a virtual marketplace. A method performed by a manager of the marketplace includes establishing a profile on a profiler for a first device that participates in a marketplace, receiving a first message that a loan request for a resource from a computing device operated by a second entity, responsive to the loan request, identifying the first entity as a candidate for providing the resource based on the profile of the first entity when the first entity has no prior history of loaning the resource, and enabling the second entity to negotiate with the first entity for a loan of the resource. The profile may characterize one or more business activities of the first entity based on one or more transactions in the marketplace.

### CROSS-REFERENCE TO RELATED APPLICATIONS

This application claims priority to and the benefit of U.S. Provisional Patent Application Ser. No. 62/358,557 filed Jul. 5, 2016, the entire content of which is incorporated herein by reference as if fully set forth below in its entirety and for all applicable purposes.

### TECHNICAL FIELD

The present disclosure relates generally to tracking, sharing, exchanging and transferring resources between entities.

### BACKGROUND

Businesses such as suppliers, manufacturers, resellers, distributors and their customers, who may also be businesses may be engaged in different activities that involve the use of common resources. For example, employees of a reseller and employees of a manufacturer may have similar skills that would permit such employees to work for either the reseller or manufacturer. In another example, tools may be usable through a supply chain. As business conditions vary, some entities may experience underutilization of resources while others may have insufficient resources to meet customer demands. Conventionally, the latter entities may seek to hire temporary employees through an employment agency, hire independent contractors, and/or rent or buy additional tools from tool suppliers.

Companies today use different means for hiring temporary employees and bringing on board new talent for a short period of time. They advertise a position through a job posting on the company's website, a sign on a store's front window, a job posting site, a word of mouth through employees or acquaintances, a recruiter, or a temporary employment agency. Recruiting temporary employees through any of the current means is time consuming, requiring screening, interviewing and reference checking to vet the employees before bringing them on board.

Entities that face a slow business period where some employees may not have any work to do, may keep the employees on the payroll in hope that business recovers and suffer lower profitability and lower employee morale as a result, layoff the employees, and/or suspend (i.e. send home) part-time or temporary employees without pay at the risk of losing such part-time or temporary employees to other employers.

### SUMMARY

Certain aspects of the disclosure relate to systems, apparatus, methods and techniques that operate a virtual and/or electronic marketplace.

According to certain aspects disclosed herein, a method performed by a manager of the marketplace includes establishing a profile on a profiler for a first device that participates in a marketplace, receiving a first message that a loan request for a resource from a computing device operated by a second entity, responsive to the loan request, identifying the first entity as a candidate for providing the resource based on the profile of the first entity when the first entity has no prior history of loaning the resource, and enabling the second entity to negotiate with the first entity for a loan of the resource. The profile may characterize one or more business activities of the first entity based on one or more transactions in the marketplace. A plurality of entities may participate in the marketplace, where each of the plurality of entities is configured to operate as one or more of a seller, a buyer or an intermediary.

In one aspect, identifying the first entity as a candidate for providing the resource includes transmitting an unsolicited second message to a computing device operated by the first entity to determine availability for loaning the resource to the second entity. The method may include providing the first entity with information identifying the second entity, and providing the first entity and the second entity with authentication information configured to enable secure communication between the first entity and the second entity.

In certain aspects, enabling the second entity to negotiate with the first entity includes providing a communication channel between the entities. The communication channel may be established between processing devices adapted to communicate using a protocol defined for a peer-to-peer network provided by the marketplace. A loan agreement may be established using an e-commerce function of the marketplace.

In certain aspects, the profile characterizes one or more business activities of the first entity based on one or more purchases made by the first entity in the marketplace. The resource may be an employee skilled in a field of work related to the one or more purchases made by the first entity in the marketplace. The resource may be a tool used in relation to the one or more purchases made by the first entity in the marketplace. The resource may include a service provided in relation to the one or more purchases made by the first entity in the marketplace. The resource may be a physical space controlled by the first entity. In one example, the physical space is a work space. In another example, the space is a conference room.

According to certain aspects disclosed herein, a method performed by a system includes receiving a notification from a first employer of an employee who is available for loan for a loan period having a minimum duration, the employee being skilled or qualified in a business activity of the first employer, identifying a second employer with a temporary need matching skills or qualifications of the employee, effecting a temporary assignment of the employee to the second employer, and after expiration of the temporary assignment, relocating the employee to a place of employment operated by the second employer. The temporary assignment may involve a physical relocation of the employee to a worksite of the first employer. The employee remains on payroll of the first employer during the temporary assignment. The employee may be vetted by the first employer.

In one aspect, the first employer is engaged in a same business activity as the second employer. The first employer and the second employer may be peers. The first employer and the second employer may be competitors. The first employer may instruct the employee regarding performance of business activities during the temporary assignment.

In one aspect, identifying the second employer includes transmitting a message to a plurality of employers, receiving a response from at least the second employer and transmitting a message to the first employer identifying the second employer.

In one aspect, the method includes maintaining a profile of the employee in a database of candidate profiles. Each candidate profile may identify a skill set, a certification or an academic qualification of a corresponding candidate.

In one aspect, the method includes sending a notification to the employee, the notification identifying the second employer, and receiving a response from employee accepting the temporary assignment.

According to certain aspects disclosed herein, a method performed by a system includes receiving a notification from a first employer with a temporary need for a person skilled or qualified in a business activity of the first employer, and identifying a second employer of an employee vetted by the second employer, possessing skills or qualifications in the business activity of the first employer, and who is available for a loan period. The method includes effecting a temporary assignment of the employee from the second employer to the first employer, and relocating the employee to a place of employment operated by the second employer after expiration of the temporary assignment. The temporary assignment may involve a physical relocation of the employee to a worksite of the first employer. The employee remains on payroll of the first employer during the temporary assignment.

In one aspect, the first employer is engaged in a same business activity as the second employer. The first employer and the second employer may be peers. The first employer and the second employer may be competitors. The second employer may instruct the employee regarding performance of business activities during the temporary assignment.

In one aspect, identifying the second employer includes transmitting a message to a plurality of employers, receiving a response from at least the second employer and transmitting a message to the first employer identifying the second employer.

In one aspect, the method includes maintaining a profile of the employee in a database of candidate profiles. Each candidate profile may identify a skill set, a certification or an academic qualification of a corresponding candidate. The system may send a notification to the employee, where the notification identifies the second employer. The system may receive a response from employee accepting the temporary assignment.

According to certain aspects, a computer readable storage medium has instructions stored thereon. The storage medium may include transitory or non-transitory storage media. The instructions may be executed by a processor such that the processor is caused to establish a profile on a profiler for a first device that participates in a marketplace, where the profile characterizes one or more business activities of the first entity based on one or more transactions in the marketplace, receive a first message from a computing device operated by a second entity, where the message includes a loan request for a resource, responsive to the request, identify the first entity as a candidate for providing the resource based on the profile of the first entity when the first entity has no prior history of loaning the resource, and enable the second entity to negotiate with the first entity for a loan of the resource.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 illustrates an example of an e-commerce system that may be implemented by a supplier.

FIG. 2 illustrates an example of an e-commerce system that may be implemented by a reseller or distributor.

FIG. 3 illustrates a system that operates a marketplace in accordance with certain aspects disclosed herein.

FIG. 4 illustrates a system that may be adapted to provide a multi-dimensioned marketplace in accordance with certain aspects disclosed herein.

FIG. 5 illustrates an example of a request initiated processed by the system of FIG. 4 in accordance with certain aspects disclosed herein.

FIG. 6 illustrates a user device that may be configured to operate in accordance with certain aspects disclosed herein.

FIG. 7 illustrates an example of an apparatus adapted in accordance with certain aspects disclosed herein.

FIG. 8 is a block diagram illustrating an example of an apparatus employing a processing system that may be adapted according to certain aspects disclosed herein.

FIG. 9 is a flow chart illustrating a first example of a method that may be employed at a transmitter in accordance with certain aspects disclosed herein.

FIG. 10 is a flow chart illustrating a second example of a method that may be employed at a transmitter in accordance with certain aspects disclosed herein.

FIG. 11 is a flow chart illustrating a third example of a method that may be employed at a transmitter in accordance with certain aspects disclosed herein.

FIG. 12 is a diagram illustrating a first example of a hardware implementation for an apparatus used in accordance with certain aspects disclosed herein.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures, and techniques may not be shown in detail in order not to obscure the embodiments.

Overview

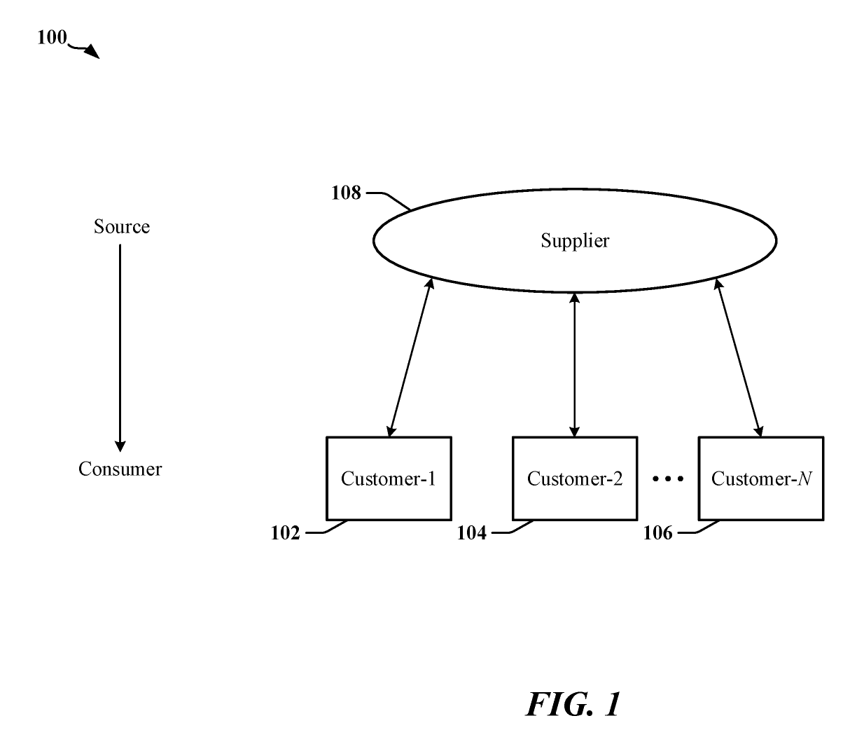

Commercial and business is increasingly transacted online. In various examples, suppliers may advertise and sell products and services online through e-commerce sites on the Internet, and employment services may seek to match employers with employees on specialized line sites on the Internet. FIG. 1 illustrates a typical e-commerce system 100 that may be implemented by a supplier 108. The supplier 108 may operate an Internet portal that allows customers 102, 104, 106 to browse, select, review, and order products or services offered by the supplier 108. The illustrated e-commerce architecture 100 may be implemented when the supplier 108 manufactures and sells a limited number of products or provides specialized services.

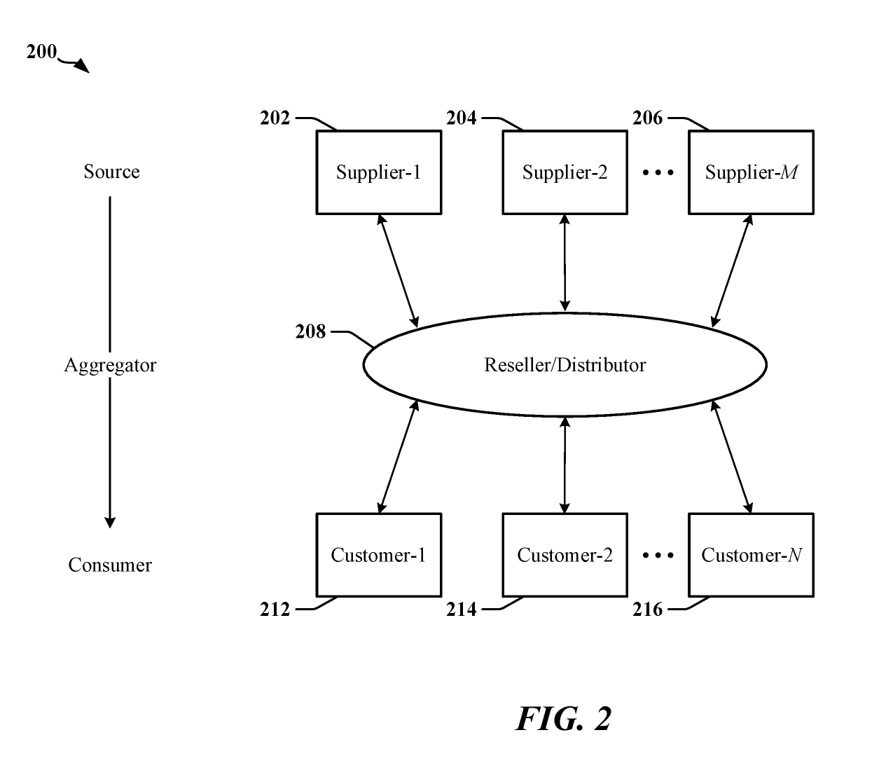

FIG. 2 illustrates another e-commerce system 200 that may be implemented by a reseller and/or distributor 208. In this example, the reseller and/or distributor 208 operates an Internet portal that allows customers 212, 214, 216 to browse, select, review, and order products and/or services offered by multiple suppliers 202, 204, 206. The portal may provide access to a wide variety of products and services and may provide the customers 212, 214, 216 with the ability to compare offerings from multiple sources. The reseller and/or distributor 208 may act as an aggregator.

The posture and functions of suppliers 108, 202, 204, 206, customers 102, 104, 106, 212, 214, 216 and reseller and/or distributor 208 are well-defined and the relationship between the suppliers 108, 202, 204, 206 and reseller and/or distributor 208, and between the customers 102, 104, 106, 212, 214, 216 and reseller and/or distributor 208 are well defined. As illustrated in FIGS. 1 and 2, unidirectional relationships facilitate the provision of products and/or services offered by a supplier 108, 202, 204, 206 to customers 102, 104, 106, 212, 214, 216. The suppliers 108, 202, 204, 206, customers 102, 104, 106, 212, 214, 216 and reseller and/or distributor 208 may independently establish other relationships. For example, a supplier 202, 204, 206 may also access the reseller and/or distributor 208 as a customer 212, 214, 216, in order to obtain components to be integrated in to a product, to obtain office supplies, etc. In these and other examples, an entity may be presented as a supplier 202, 204, 206 for a first transaction and as a customer 212, 214, 216 in another transaction. Conventional e-commerce systems 100, 200 have limited or no ability to support more complex business relationships between suppliers 108, 202, 204, 206, resellers and/or distributors 208 and/or the customers 102, 104, 106, 212, 214, 216.

Certain aspects of the invention provide a broader range of inter-relationships between entities that operate within an e-commerce systems. Certain technological solutions disclose herein address problems arising from the inability of conventional e-commerce systems to support multi-level interconnections between entities that may operate concurrently as buyers, sellers, suppliers, lenders, borrowers, contractors, consultants, etc. Certain aspects disclosed herein provide unconventional technological solutions that enable parties to communicate needs and surpluses, and that enable participants to react to changing circumstances.

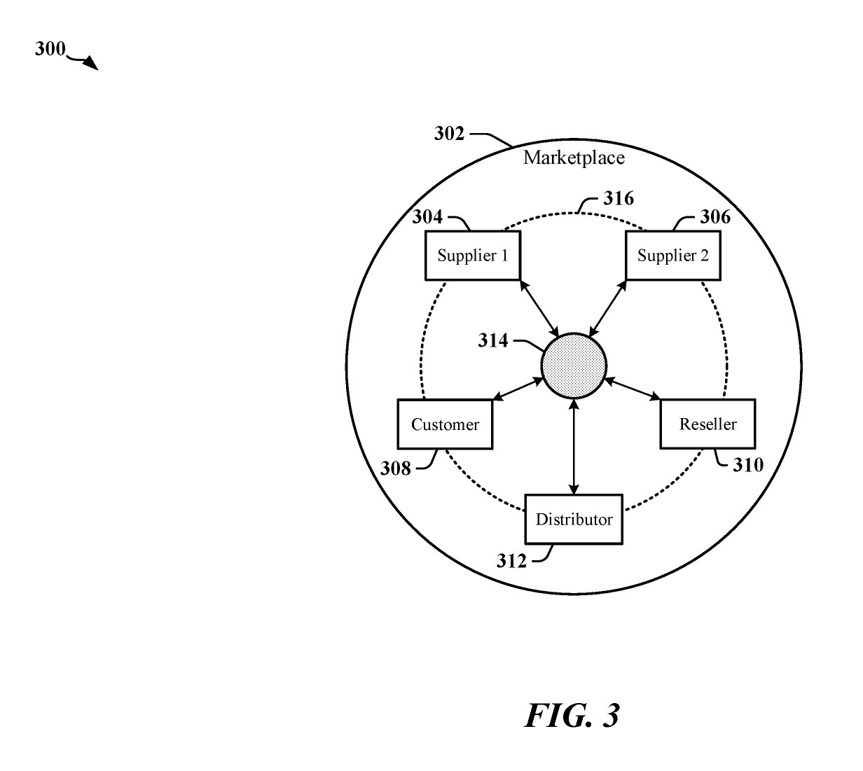

FIG. 3 is a conceptual diagram 300 illustrating a system 314 that may be adapted to operate a marketplace 302. The marketplace 302 may encompass a plurality of entities that may have multiple functions or engage in multiple activities concurrently in the marketplace 302. The system 314 may be adapted or configured to perform a variety of functions and/or services, including authentication, messaging, and conventional e-commerce services. The system 314 may enable peer-to-peer communication 316 in addition to communications with the system 314. The entities may be configured as suppliers 304, 306, a reseller 310, a distributor 312 and a customer 308. In one example, a customer 308 may use the e-commerce services to obtain products or services from a distributor 312, a reseller 310 or a supplier 304, 306.

According to certain aspects, the system 314 may be configured to enable participants in the marketplace 302 to engage in a variety of transactions that may involve peer-to-peer interactions. Businesses engaged in similar business activities may cooperate in an employee-sharing and/or a tool-sharing service enabled by the system 314.

First Example of a Multi-Dimensioned Marketplace

Certain aspects disclosed herein permit a first business entity to quickly identify and bring on board an employee of a second business entity, as temporary employee or contractor on for a relatively short period of time. The temporary employee or contractor may be acquired on loan from the second business entity. The first business entity and the second business entity may have no prior relationship, may have a supplier-customer relationship, and/or may be competitors. The first business entity may use the marketplace 302 to identify and select individuals, groups or teams that are available to help the first business entity fulfill short term objectives, handle surges in business activities, reach short-term project targets and/or serve as a backup in response to unexpected events. The identified employees may meet a set of criteria defined by the business entity including, for example, skill sets, availability, associated cost, geographic location, etc. The employees may be assigned to work on a given project or series of projects or tasks without incurring the liabilities associated with hiring these employees.

According to certain aspects, the system 314 operating the marketplace 302 may maintain information that can be used to match the first business entity that is seeking employees on a short-term basis with a second business entity that may have idle or under-utilized employees. The system 314 may identify potential matches using historical information and information obtained from prior activities of various business entities. In one example, the system 314 may prioritize matches based on one or more prior loan agreements between the first business entity and the second business entity.

In another example, the system 314 may prioritize matches based on one or more prior transactions between the first business entity and the second business entity that involved acquisition of products or services and that indicated common field of business. In another example, the system 314 may prioritize matches based on transactions between a third party and each of the first business entity and the second business entity that involved acquisition of products or services and that indicated common field of business. In another example, the system 314 may prioritize matches based on common employee certifications required by first business entity and the second business entity, or similar vetting procedures used by the entities to qualify permanent employees.

The system 314 may match the first business entity with the second business entity based on a determination that employees of the entities share certain common skill sets. In some instances, the system 314 may maintain information indicating the availability of employees available for loan and can quickly respond to a loan request from the first business entity. The system 314 may respond to a loan request from the first business entity by messaging entities that have candidates for loan, or that may be active in the same field of activity and/or within a suitable geographic location relative to the first business entity. The system 314 may act as an intermediary in the search for temporary employees and/or may provide more direct communication between entities.

The system 314 may enable the first business entity to bring vetted employees on board quickly, without resorting to interviewing, reference checking and a long and laborious screening process. In many instances, the identified employees may be performing similar projects or tasks, and/or may possess qualifications required or desired by the business entity. In one example, an automotive repair establishment may seek employees that are certified by manufacturers of certain brands of automobile.

In conventional systems, companies use different means for hiring temporary employees and bringing on board new talent for a short period of time. A position may be advertised through a job posting on a company website, a storefront sign posted on a window, a job posting site, word of mouth through employees or acquaintances, a recruiter, or a temporary employment agency. These conventional methods can be haphazard and recruiting temporary employees through any of the current means is time consuming, requiring screening, interviewing and reference checking to vet the employees before bringing them on board.

Certain aspects disclosed herein can provide hiring entities with a more focused, relevant and efficient search process that is based on knowledge acquired by the system 314 from information acquired from a variety of types of transaction. For example, the system 314 may have access to information that indicates or identifies entities that face a slow business period. In slow business periods, some employees may be underutilized or idle. An employer may keep the employees on the payroll in hope that business recovers and suffer lower profitability and lower employee morale as a result, layoff the employees, and/or suspend (i.e. send home) part-time or temporary employees without pay at the risk of losing such part-time or temporary employees to other employers. In accordance with certain aspects disclosed herein, the system 314 enables participants in the marketplace 302 may routinely and efficiently identify opportunities to lend underutilized employees to other participants with an expressed need. Participants may proactively notify the system 314 of the availability of employees for loan or may respond to a request or inquiry directed through the system 314. Certain aspects disclosed herein provide technological means that provides effective human resources solution for cyclical markets in which the business level and need for employees varies multiple times and considerably throughout the year.

Second Example of a Multi-Dimensioned Marketplace

Certain aspects disclosed herein permit business entities to quickly identify a source and availability of tools, parts, equipment, devices, furniture, machines, accessories or other assets that may be borrowed or rented. A first entity may offer an asset for loan or rent proactively or in response to a request or enquiry from a second entity. The asset may be acquired on loan by a second entity. The first and second entities may have no prior relationship, may have a supplier-customer relationship, and/or may be competitors. The second business entity may use the marketplace 302 to identify and select assets that are needed to help the business entity fulfill short term objectives, handle surges in business activities, reach short-term project targets and/or serve as a backup in response to unexpected events.

According to certain aspects, the system 314 operating the marketplace 302 may maintain information that can be used to match the second business entity that is seeking assets for loan or rent on a short-term basis with a second business entity that may have surplus or under-utilized assets. The system 314 may identify potential matches using historical information and information obtained from prior activities of various business entities. In one example, the system 314 may prioritize matches based on one or more prior loan agreements between the first business entity and the second business entity.

In another example, the system 314 may prioritize matches based on one or more prior transactions between the first business entity and the second business entity that involved acquisition of products or services and that indicated common field of business. In another example, the system 314 may prioritize matches based on transactions between a third party and each of the first business entity and the second business entity that involved acquisition of products or services and that indicated common field of business. In another example, the system 314 may prioritize matches based on purchases by first business entity and the second business entity.

In some instances, the system 314 may maintain information indicating the availability of assets available for loan and can quickly respond to a loan request from the second business entity. The system 314 may respond to a loan request from the second business entity by messaging entities that have matching assets for loan, or that may be active in a participant that operates in the same field of activity and/or located within a suitable geographic location relative to the second business entity. The system 314 may act as an intermediary in the search for assets and/or may provide more direct communication between entities.

The system 314 may enable the second business entity to rapidly acquire access to specialized or rarely-used tools. In one example, an automotive repair establishment may seek specialized tools from other repair establishments equipped to service vehicles from a common manufacturer.

First Example of a Multi-Dimensioned Marketplace

A system 314 provided in accordance with certain aspects disclosed herein permit business entities to quickly identify providers of services that may be of service within the business environment. A first entity may seek specialized services that can be provided by a second entity that is active within the marketplace 302. The first and second entities may have no prior relationship, may have a supplier-customer relationship, and/or may be competitors. The first business entity may use the marketplace 302 to identify and select services that are needed to help the business entity fulfill short term objectives, handle surges in business activities, reach short-term project targets and/or serve as a backup in response to unexpected events.

According to certain aspects, the system 314 operating the marketplace 302 may maintain information that can be used to match the first business entity that is seeking services with a second business entity that may be equipped to provide such services. The system 314 may identify potential matches using historical information and information obtained from prior activities of various business entities. In one example, the system 314 may prioritize matches based on one or more prior loan agreements between the first business entity and the second business entity.

In another example, the system 314 may prioritize matches based on one or more prior transactions between the first business entity and the second business entity that involved acquisition or provision of services that indicate a common field of business. In another example, the system 314 may prioritize matches based on transactions between a third party and each of the first business entity and the second business entity that involved acquisition or services that indicate a common field of business. In another example, the system 314 may prioritize matches based on purchases by first business entity and the second business entity.

In some instances, the system 314 may maintain information indicating the availability of services available from one or more entities, and can quickly respond to a request for such services from the first business entity. The system 314 may respond to a request from the first business entity by messaging entities that match criteria provided by the first entity and/or the system 314 or by messaging entities that may be active in a participant that operates in the same field of activity and/or located within a suitable geographic location relative to the first business entity. The system 314 may act as an intermediary in the search for assets and/or may provide more direct communication between entities.

Example of a System Adapted to Provide a Multi-Dimensioned Marketplace

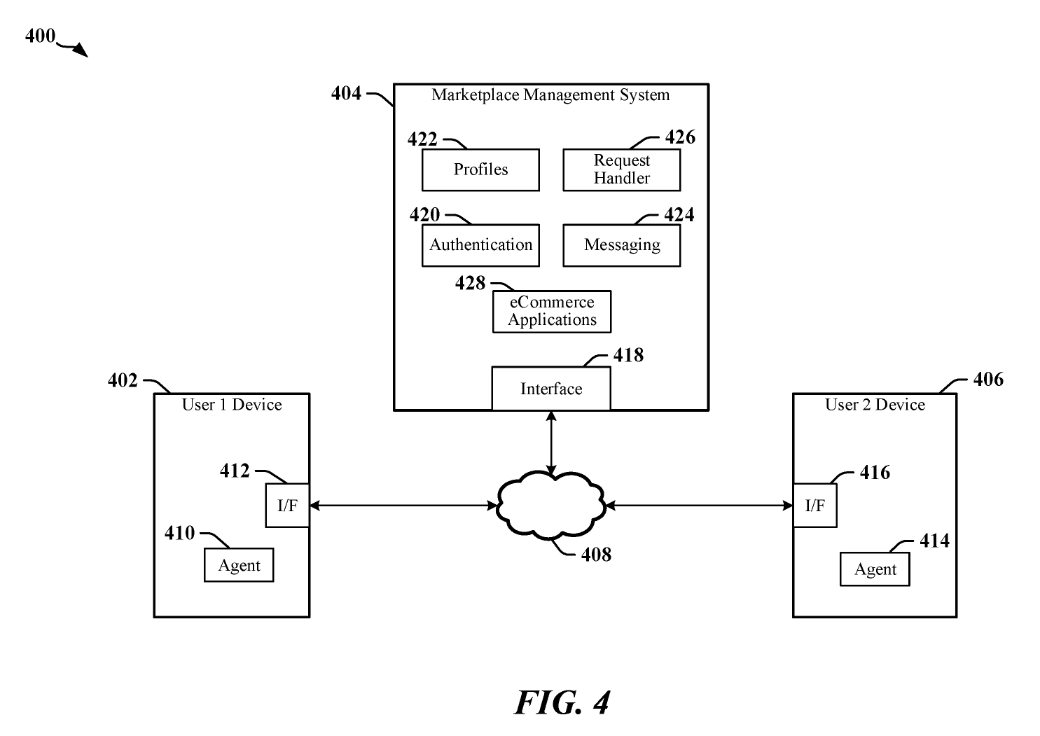

FIG. 4 illustrates certain aspects and features of a system 404 that may be adapted to provide a multi-dimensioned marketplace 400. The system 404 may be implemented using one or more networked devices configured to perform at least a portion of one or more functions 420, 422, 424, 426. In one example, the system 404 includes multiple collocated networked devices. In another example, the system 404 includes multiple networked devices including networked devices that deployed in physically different locations including devices located in different cities, countries or continents.

The system 404 may comprise local and wide area networks, including a public land mobile network, and/or one or more WiFi or other radio access networks interconnected using wired or optical network segments. In one example, a mobile communication device may access the disclosed system using a cellular network, a WiFi network, and/or a wired local area network.

One or more servers may be deployed to register employees, assets, services and business entities, receive requests for loans, send notifications to interested parties, and to match loan request with available employees. In one example, one or more functions may be configured to search available employees when a loan request is received. The network function may determine which employers and/or employees should be notified of an applicable or relevant loan request. In one example, the network function may send an SMS message to all matching employees and/or their employer. In another example, the network function may classify and/or prioritize the potential employees and notify a top percentage representing the best possibilities.

Various network functions may be protected by security features, and may be provided behind firewalls intended to prevent unauthorized access to the system. In some examples, the parties access the system through secured connections and/or tunnels that may be established using cryptographic techniques.

The system 404 may be coupled to one or more networks 408 through a network interface 418. The networks 408 may include distinctly different networks, including one or more local area networks that interconnect constituents of the system 404, wired telecommunication networks and wireless telecommunication networks. The system 404, servers and/or functions 420, 422, 424, 426 included in the system 404 and devices 402, 406 operated by participants of the marketplace 400. One or more network protocols, such as Internet protocols, may facilitate communication involving between the functions 420, 422, 424, 426.

The system 404 may include an authentication server or function 420 that is adapted to validate participants and/or participant devices 402, 406. The authentication server or function 420 may cooperate with a profile server or function 422 that maintains information identifying participants and/or participant devices 402, 406. The profile server or function 422 may maintain information characterizing entities that are registered with the system 404 and/or that otherwise participate in the marketplace 400. The profile server or function 422 may track participant activities. In some instances, the characterization of an entity may be based on a history of activity in the marketplace 400. The profile server or function 422 may include information provided by a participant or other registered user. Information maintained and or sourced by the profile server or function 422 may be used to automatically direct messages, requests, opportunities and other information that may be of value to a profiled participant. The messages, requests, opportunities and other information may relate to activities that are secondary to the participant's use of the marketplace 400. In one example, a first participant engaged in the automotive repair business may regularly purchase parts in the marketplace 400 and may be identified as a potential source of tools or personnel that could be borrowed by a second participant of the marketplace 400. In the latter example, the first participant may be identified as a loan source without any prior activity as a loaning entity, as a borrower, as a seller, etc.

According to certain aspects, the profile server or function 422 may include information that identifies assets, services, and/or resources that may be available or usable by another participant of the marketplace 400. In one example, the profile server or function 422 may maintain a list of assets, services, and/or resources owned and/or controlled by a participating entity, that may be of value or otherwise available to another entity. Assets, services, and/or resources, may be available from an entity that is experience a period of low activity and may be willing to lend, rent or otherwise provide assets, services, and/or resources on a temporary or permanent basis.

The system 404 may include one or more servers that are adapted to support e-commerce applications 428. E-commerce applications 428 may be deployed to provide a platform on which selling entities can list, advertise and sell products and services. E-commerce applications 428 may include applications configured to accept and validate payments purchased or contracted through other e-commerce applications 428. Participants in the marketplace 400 may access e-commerce applications 428 to purchase or sell products and services.

The system 404 may include one or more servers that support a messaging function 424. The messaging function 424 may be configured to support communications relating to the e-commerce applications 428. The messaging function 424 may be further configured to support communications that relate to other activities that have direct, indirect or no relationship to the e-commerce applications 428. For example, the messaging function 424 may be configured to push messages to a first user device 402 that are identified by the profile server or function 422 as being a potential source of personnel, physical assets and/or services that can be loaned to satisfy a business need or requirement of a second user.

Requests and/or inquiries related to the lending of personnel, physical assets and/or services may be processed and/or generated by a request handler 426 provided in the system 404. In some instances, a requesting entity may request temporary access to or use of a resource. The request may originate at a user device 402, 406 as a query regarding availability for transfer of a suitable resource. The request may be sent to the system 404 in a message that is received by the messaging function 424. The messaging function 424 may direct the request to the request handler 426, which may cooperate with the profile server or function 422 to identify participating entities that were involved in a previous similar request, participating entities that have been determined to operate in the same field as the requesting entity. The messaging function 424 may then be tasked with notifying various candidates for sourcing suitable personnel, physical assets and/or services for temporary allocation to the requesting entity. In some instances, the request may be received from an entity that has personnel, physical assets and/or services that are available for loan, and the messaging function 424 may push notifications to candidates that have been identified as having a potential short term need for the personnel, physical assets and/or services.

A first entity responding to a request may negotiate with by a requesting second entity to agree terms by which a resource may be transferred on a temporary basis. The system 404 may facilitate a connection between negotiating entities, and/or may provide adaptable contractual arrangements through e-commerce applications 428. The entities may transfer the resource in accordance with terms agreed between the first entity and the second entity.

The messaging function 424 may push messages that include information that permits a candidate to review the specifics of a request in order to determine if the candidate is able to satisfy the need expressed in the request. The messages may also include information that allows the candidate to contact and/or enter negotiations with the requester. In some instances, a message may include one or more links that enable an authenticated candidate to automatically contact or initiate a negotiation procedure with the requester.

According to certain aspects, the messaging function 424 may provide information including parameters, identifiers, codes and/or links that enable participants to cause a user device 402, 406 to enter a preconfigured communication and/or negotiation session related to personnel, physical assets and/or services that may be exchanged for a loan period. The parameters, identifiers, codes and/or links may activate and/or configure one or more functions 420, 422, 424, 426, 428 of the system 404. The parameters, identifiers, codes and/or links may be transmitted to an individual participant or a class of participants.

Example of Request Flow

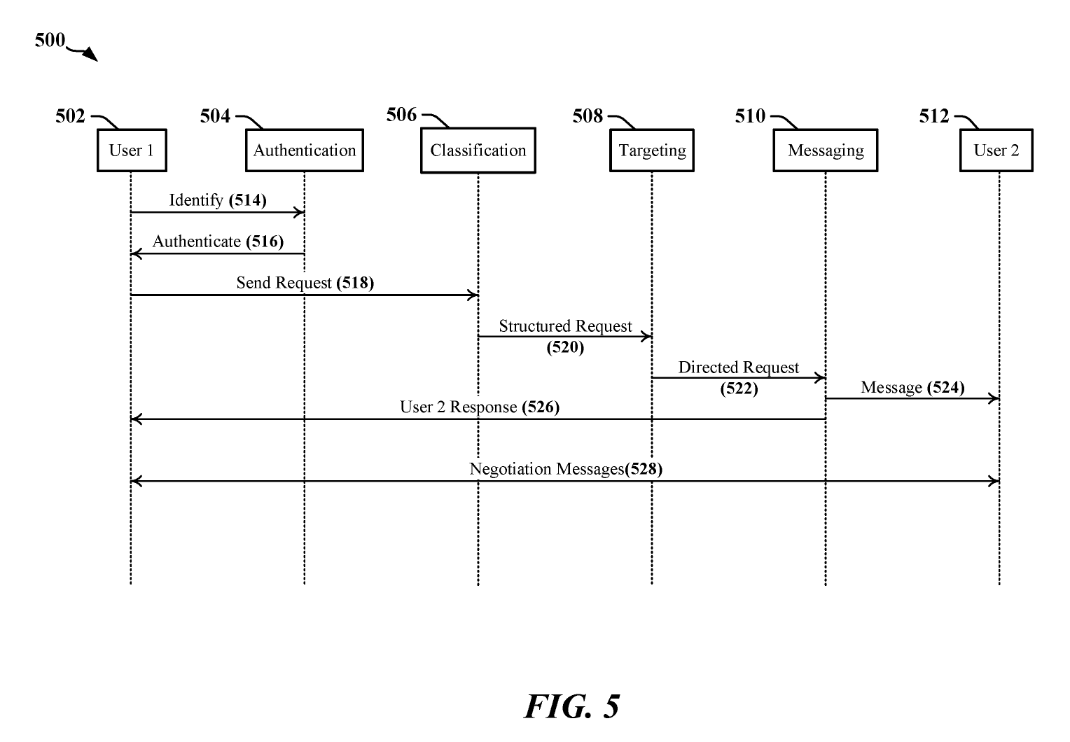

FIG. 5 illustrates an example in which a request initiated by a first user 502 may be processed by the system 404 of FIG. 4. Business entities participating in a marketplace 400 may access the system 404 using a user device 402, 406 that includes processing circuit adapted or configured according to certain aspects disclosed herein. In one example, the user device 402, 406 may be a mobile communication device or a web application desktop device. An application or agent 410, 414 provided in the user device 402, 406 may be used to solicit vetted employees, physical assets and/or services for borrowing. The user device may include credentials, cryptographic keys and the like to enable the business entity to establish a secure, authenticated connection with the system in order to maintain privacy of the business entity and employees, while enabling the system 404 to validate loan requests and acceptances.

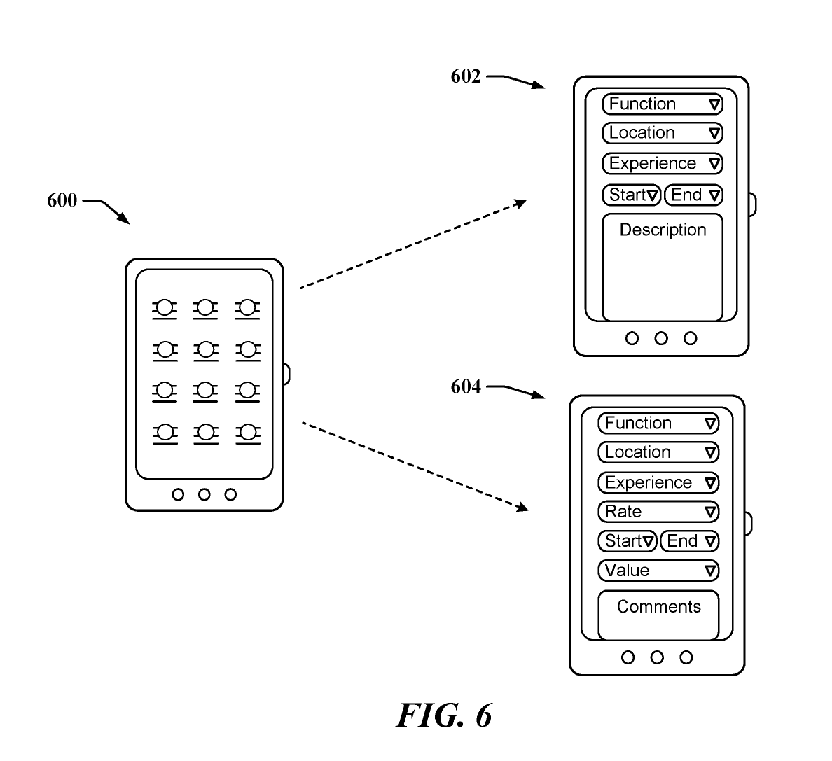

A first user 502 may exchange identification and authentication information 514 with an authentication function 504. The authentication function 504 may validate the identity of the first user 502 and send authenticating information 516 that may include cryptographic keys needed to communicate with the system 404. The first user 502 may then send a request 518 to a classification function 506 of the system 404. The classification function 506 may be implemented using a combination of components such as the profile server or function 422, the request handler 426, e-commerce applications 428, and/or other components. The classification function 506 may determine the nature of the request. The classification function 506 may provide a structured request 520 to a targeting function 508 that identifies certain characteristics of the request and/or requester. The targeting function 508 may identify candidates using the profile server or function 422. The targeting function 508 may send one or more directed requests 522 to the messaging function 424 to push directed messages 52 to candidates, including a second user 512. The directed requests 522 may include information that permits the second user 512 to review the specifics of the request in order to determine if the second user 512 is able to satisfy the need expressed in the request. The second user 512 may transmit a message 526 that is directly, or indirectly provided to the first user 502 indicating that the second user 512 can satisfy the request. Negotiations between the first user 502 and the second user 512 may then be initiated through one or more messages 528. FIG. 6 illustrates a user device 600 that may be configured to operate in support of an entity seeking to borrow personnel (see the first display 602), and/or in support of an entity seeking to lend personnel (see the second display 604).

According to certain aspects, a user device 402, 406 may be implemented using an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

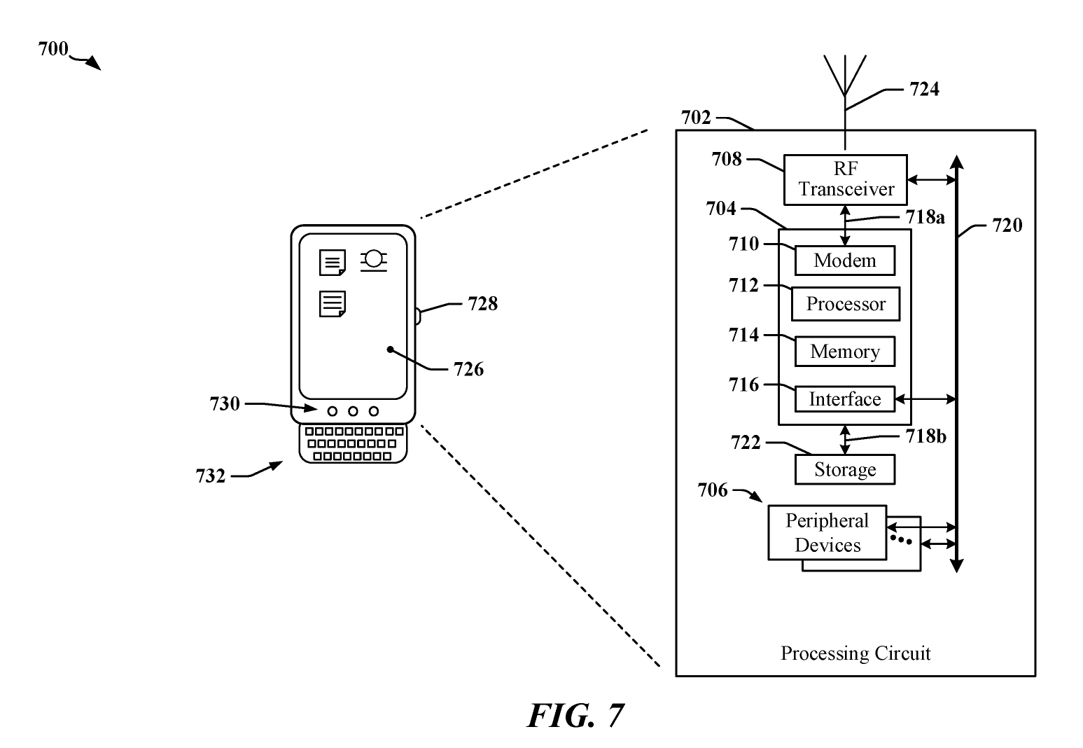

FIG. 7 illustrates an example of an apparatus 700 that may be adapted to serve as the user device 402, 406. The apparatus 700 may include a processing circuit 702 having multiple circuits or devices 704, 706 and/or 708, which may be implemented in one or more ASICs or in an SoC. In one example, the apparatus 700 may be a communication device and the processing circuit 702 may include a processing device provided in an ASIC 704, one or more peripheral devices 706, and a transceiver 708 that enables the apparatus to communicate through an antenna 724 with a radio access network, a core access network, the Internet and/or another network.

The ASIC 704 may have one or more processors 712, one or more modems 710, on-board memory 714, a bus interface circuit 716 and/or other logic circuits or functions. The processing circuit 702 may be controlled by an operating system that may provide an application programming interface (API) layer that enables the one or more processors 712 to execute software modules residing in the on-board memory 714 or other processor-readable storage 722 provided on the processing circuit 702. The software modules may include instructions and data stored in the on-board memory 714 or processor-readable storage 722. The ASIC 704 may access its on-board memory 714, the processor-readable storage 722, and/or storage external to the processing circuit 702. The on-board memory 714, the processor-readable storage 722 may include read-only memory (ROM) or random-access memory (RAM), electrically erasable programmable ROM (EEPROM), flash cards, or any memory device that can be used in processing systems and computing platforms. The processing circuit 702 may include, implement, or have access to a local database or other parameter storage that can maintain operational parameters and other information used to configure and operate the apparatus 700 and/or the processing circuit 702. The local database may be implemented using registers, a database module, flash memory, magnetic media, EEPROM, soft or hard disk, or the like. The processing circuit 702 may also be operably coupled to external devices such as the antenna 724, a display 726, operator controls, such as switches or buttons 728, 730 and/or an integrated or external keypad 732, among other components. A user interface module may be configured to operate with the display 726, keypad 732, etc. through a dedicated communication link or other data interconnect.

The processing circuit 702 may provide one or more buses 718a, 718b, 720 that enable certain devices 704, 706, and/or 708 to communicate. In one example, the ASIC 704 may include a bus interface circuit 716 that includes a combination of circuits, counters, timers, control logic and other configurable circuits or modules.

Detailed Example Involving Personnel Lending

Certain aspects disclosed herein provide a novel approach that permits a business entity to quickly identify and bring on board employees and for a relatively short period of time. The business entity may identify and select individuals, groups or teams that are available to help the business entity fulfill short term objectives, handle surges in business activities, reach short-term project targets and/or serve as a backup in response to unexpected events. The identified employees may meet a set of criteria defined by the business entity including, for example, skill sets, availability, associated cost, geographic location, etc. The employees may be assigned to work on a given project or series of projects or tasks without incurring the liabilities associated with hiring these employees.

The business entity may bring vetted employees on board quickly, without resorting to interviewing, reference checking and a long and laborious screening process. In many instances, the identified employees may be performing similar projects or tasks, and/or may possess qualifications required or desired by the business entity. In one example, an automotive repair establishment may seek employees that are certified by manufacturers of certain brands of automobile.

The business entity may participate in a system that provides access to short-term resources and may employ a processing device adapted or configured according to certain aspects disclosed herein. In one example, the business entity may employ an application on a mobile communication device or a web application to solicit vetted employees for borrowing. The mobile communication device may include credentials, cryptographic keys and the like to enable the business entity to establish a secure, authenticated connection with the system in order to maintain privacy of the business entity and employees, while validating loan requests and acceptances.

The system, and methods employed by the system facilitate a humane approach to dealings between employers and employees when circumstances dictate that the employees are not needed for a predetermined period of time. The employees can be loaned by the employers such that losses of profits are prevented or minimized. The employees maintain their state of employment and income may continue to receive benefits associated with their employment.

The method provides businesses with an opportunity to retain employees that would otherwise be motivated to leave the company due to loss of income or lack of work to do.

This method involves conducting a peer to peer transaction consisting of borrowing and loaning employees. In one example, the peer businesses may be automotive repair shops. Other examples of peer businesses include, but are not limited to, hotels, restaurants, coffee shops, bars, nightclubs, construction contractors, retailers, and a variety of small and medium businesses.

According to certain aspects, loaning and borrowing is facilitated by a third party online or mobile platform that can simplify, speed and automate the borrowing and loaning of employees between peer businesses. The resultant service may provide notifications of availability or need to enrolled or interested parties in a fast and automated fashion.

By using mobile device push notifications or emails, an employer or business owner A, who is registered as a member of a specific peer group, can send text messages or emails to a wide range of peer employers and business owners to inform them of his/her need to borrow an employee.

Business owners who are members of the service and opt to receive such notifications from peer businesses will receive either a text message, an email or both from the business owner A.

Business owner B, interested in bringing on board employee working for owner A, will be able to reserve the employee and enter in a financial arrangement with business owner A.

In another situation where business owner C wanting to loan an employee or employees to avoid cutting their hours, laying them off, or having them sit idle with no work to do, can send notifications informing other businesses of the availability for loan of an employee or employees with specific skills, experience and capabilities.

Business owner D, interested in borrowing said employees will be able to reserve the employees and enter into a financial arrangement with business owner C to borrow the employees for the pre-determined period.

The second method enables employers to easily advertise vetted employees to be loaned by using a mobile application or web application.

Example of System Registration

According to certain aspects, a registration process is implemented whereby employers seeking employees to borrow identify the position, job or function they are looking to fulfill with the specific skills they desire, the location of the employees relative to their place of employment and the timeframe in which the employees are required to perform their jobs. A computer or mobile device's GPS functionality helps specify the perimeter in which the employees can be located relative to the place of employment. Employers amenable to loaning employees define the parameters for which they would like to receive instant notifications, including the desired employees' functions, how frequently they wish to receive notifications and how they would like to receive these notifications.

According to certain aspects, a registration process is implemented whereby employers seeking to loan employees identify the employees' current profiles including their positions in the business, their years of experience in one or more function, the timeframe that the employers can make the employees available for borrowing and the distance that the employees are willing to travel to work. Employers amenable to borrowing employees define the parameters for which they would like to receive instant notifications, including the available employees' functions, how frequently they wish to receive notifications and how they would like to receive these notifications.

Terms and Conditions of use, that all registered businesses (referred to as members) should agree to ensure that an employer borrowing an employee cannot hire this employee for a pre-determined period of time. The Terms and Conditions also state that loaned employees remain employees of their employer during the entire loan period and the employer is responsible and liable for their employees, pays their salary or wages and all their insurance and other benefits. During the loan period, loaned employees continue to report to their employer and follow the lead of their temporary supervisor, the employer who borrowed them, during the loan period.

A matching algorithm comparing an employer's employee profile with a list of employees working for peer businesses in the database will trigger a new service that will target employers with matching employee profiles and provide them with incentives to loan their employees.

A dispatching algorithm based on SMS and email messages and corresponding to a member preferences and parameters entered in the web or mobile application, will trigger automatic messages to all employers with employees that match the desired profiles and encourage them to respond to the request.

After the loaning period is completed, employers will have the opportunity to rate the employees they borrow and submit reviews that the system will keep track of and share with future potential employers. All loaned employees will be provided identities to keep their names anonymous until a loaning transaction is concluded and the identities will be associated with ratings and reviews. The ratings and reviews will be another means for employers to evaluate employees and eliminate the vetting process.

All members are required to agree to the Terms and Conditions of Use and Privacy Policy of the portal site and mobile application, in order to become members and be authorized to use the service. The Terms and Conditions define the responsibilities and obligations of each party, cancellation policy and requests for cancellation, refund policy, payments, liabilities, payment of employees, worker's insurance and other benefits.

In some aspects, contracts may be generated to establish rights and obligations under a loan agreement, including financial arrangements, delegation of rights and obligations from loaning business to the borrowing business, etc. The contracts may be automatically generated in accordance with limitations specified by the businesses. The automated contracts can then be presented to the loaning business to the borrowing business for acknowledgement and acceptance of the terms and conditions, and/or for electronic signature.

Termination of the loan contract may be defined in the terms agreed upon by the parties, except that a clause in the terms and conditions may impose a cancellation fee equal to some portion of the costs associated with the borrowed employee. For example, the cancellation fee may be calculated as the employee's 1st day salary, if the cancellation occurs before the end of the employee's 1st day shift. The cancellation fee may be calculated using agreed term of loan, costs to the loaning business associated with the loaned employee and so on.

Examples of Processing Circuits and Methods

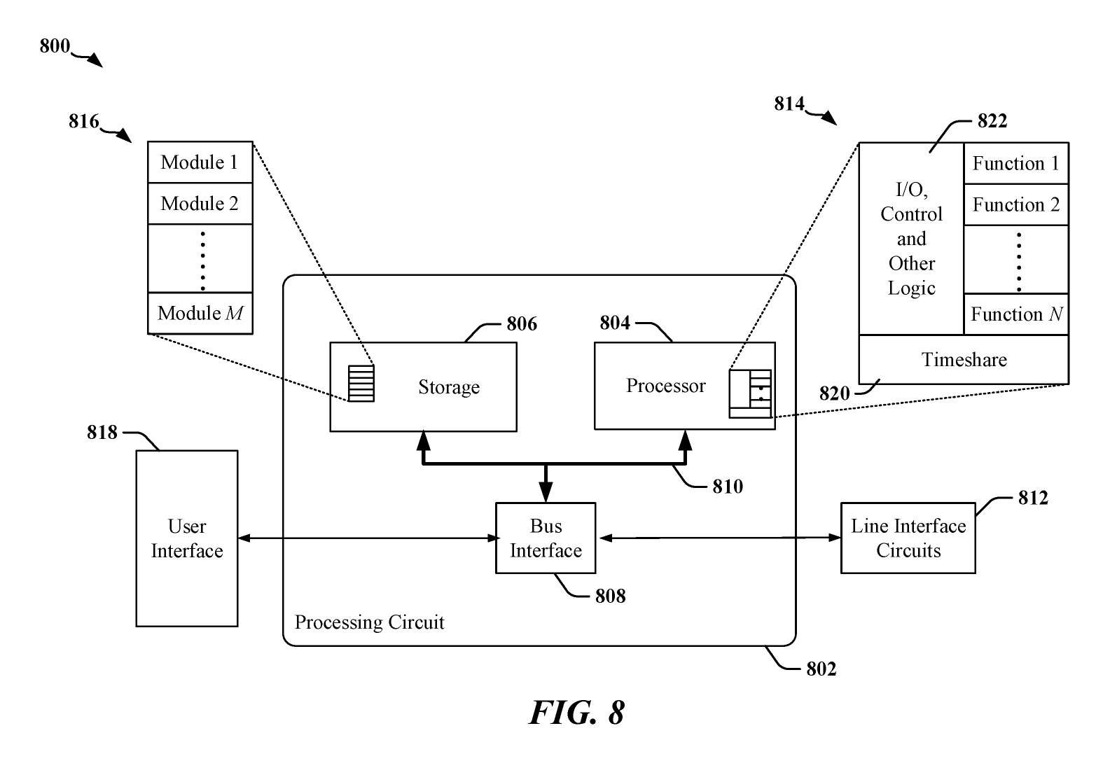

FIG. 8 is a conceptual diagram 800 illustrating an example of a hardware implementation for an apparatus employing a processing circuit 802 that may be configured to perform one or more functions disclosed herein. In accordance with various aspects of the disclosure, an element, or any portion of an element, or any combination of elements as disclosed herein may be implemented using the processing circuit 802. The processing circuit 802 may include one or more processors 804 that are controlled by some combination of hardware and software modules. Examples of processors 804 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 804 may include specialized processors that perform specific functions, and that may be configured, augmented or controlled by one of the software modules 816. The one or more processors 804 may be configured through a combination of software modules 816 loaded during initialization, and further configured by loading or unloading one or more software modules 816 during operation.

In the illustrated example, the processing circuit 802 may be implemented with a bus architecture, represented generally by the bus 810. The bus 810 may include any number of interconnecting buses and bridges depending on the specific application of the processing circuit 802 and the overall design constraints. The bus 810 links together various circuits including the one or more processors 804, and storage 806. Storage 806 may include memory devices and mass storage devices, and may be referred to herein as processor-readable media and/or computer-readable media. The bus 810 may also link various other circuits such as timing sources, timers, peripherals, voltage regulators, and power management circuits. A bus interface 808 may provide an interface between the bus 810 and one or more transceivers 812. A transceiver 812 may be provided for each networking technology supported by the processing circuit. In some instances, multiple networking technologies may share some or all of the circuitry or processing modules found in a transceiver 812. Each transceiver 812 provides a means for communicating with various other apparatus over a transmission medium. Depending upon the nature of the apparatus, a user interface 818 (e.g., keypad, display, touch interface, speaker, microphone, joystick) may also be provided, and may be communicatively coupled to the bus 810 directly or through the bus interface 808.

A processor 804 may be responsible for managing the bus 810 and for general processing that may include the execution of software stored in a processor-readable medium that may include the storage 806. In this respect, the processing circuit 802, including the processor 804, may be used to implement any of the methods, functions and techniques disclosed herein. The storage 806 may be used for storing data that is manipulated by the processor 804 when executing software, and the software may be configured to implement any one of the methods disclosed herein.

One or more processors 804 in the processing circuit 802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in processor-readable form in the storage 806 or in an external computer readable medium. The external processor-readable medium and/or storage 806 may include a non-transitory processor-readable medium. A non-transitory processor-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The processor-readable medium and/or storage 806 may also include, by way of example, a carrier wave, a transmission line, and any other suitable medium for transmitting software and/or instructions that may be accessed and read by a computer. Processor-readable medium and/or the storage 806 may reside in the processing circuit 802, in the processor 804, external to the processing circuit 802, or be distributed across multiple entities including the processing circuit 802. The processor-readable medium and/or storage 806 may be embodied in a computer program product. By way of example, a computer program product may include a processor-readable medium in packaging materials. Those skilled in the art will recognize how best to implement the described functionality presented throughout this disclosure depending on the particular application and the overall design constraints imposed on the overall system.

The storage 806 may maintain software maintained and/or organized in loadable code segments, modules, applications, programs, etc., which may be referred to herein as software modules 816. Each of the software modules 816 may include instructions and data that, when installed or loaded on the processing circuit 802 and executed by the one or more processors 804, contribute to a run-time image 814 that controls the operation of the one or more processors 804. When executed, certain instructions may cause the processing circuit 802 to perform functions in accordance with certain methods, algorithms and processes described herein.

Some of the software modules 816 may be loaded during initialization of the processing circuit 802, and these software modules 816 may configure the processing circuit 802 to enable performance of the various functions disclosed herein. For example, some software modules 816 may configure internal devices and/or logic circuits 822 of the processor 804, and may manage access to external devices such as the transceiver 812, the bus interface 808, the user interface 818, timers, mathematical coprocessors, and so on. The software modules 816 may include a control program and/or an operating system that interacts with interrupt handlers and device drivers, and that controls access to various resources provided by the processing circuit 802. The resources may include memory, processing time, access to the transceiver 812, the user interface 818, and so on.

One or more processors 804 of the processing circuit 802 may be multifunctional, whereby some of the software modules 816 are loaded and configured to perform different functions or different instances of the same function. The one or more processors 804 may additionally be adapted to manage background tasks initiated in response to inputs from the user interface 818, the transceiver 812, and device drivers, for example. To support the performance of multiple functions, the one or more processors 804 may be configured to provide a multitasking environment, whereby each of a plurality of functions is implemented as a set of tasks serviced by the one or more processors 804 as needed or desired. In one example, the multitasking environment may be implemented using a timesharing program 820 that passes control of a processor 804 between different tasks, whereby each task returns control of the one or more processors 804 to the timesharing program 820 upon completion of any outstanding operations and/or in response to an input such as an interrupt. When a task has control of the one or more processors 804, the processing circuit is effectively specialized for the purposes addressed by the function associated with the controlling task. The timesharing program 820 may include an operating system, a main loop that transfers control on a round-robin basis, a function that allocates control of the one or more processors 804 in accordance with a prioritization of the functions, and/or an interrupt driven main loop that responds to external events by providing control of the one or more processors 804 to a handling function.

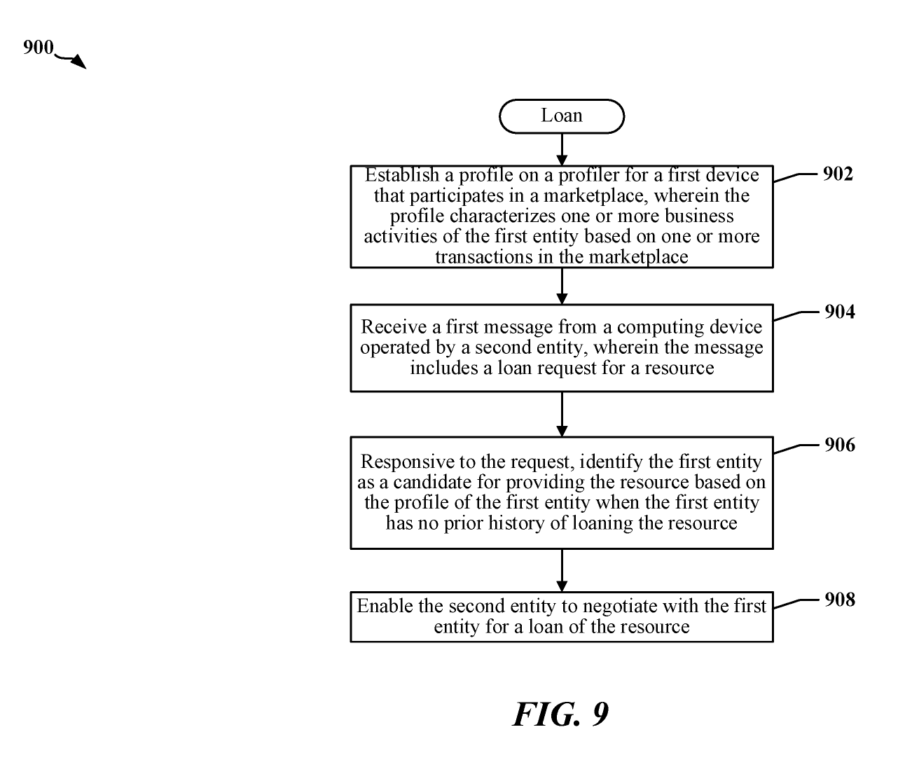

FIG. 9 is a flowchart illustrating a method for operating a virtual marketplace. At block 902, the system may establish a profile on a profiler for a first device that participates in a marketplace. The profile may characterize one or more business activities of the first entity based on one or more transactions in the marketplace. A plurality of entities may participate in the marketplace. Each of the plurality of entities may be configured to operate as one or more of a seller, a buyer or an intermediary.

At block 904, the system may receive a first message from a computing device operated by a second entity. The message may include a loan request for a resource.

At block 906, the system may identify the first entity as a candidate for providing the resource after receiving the request. The system may identify the first entity based on the profile of the first entity when the first entity has no prior history of loaning the resource. In identifying the first entity, the system may transmit an unsolicited second message to a computing device operated by the first entity to determine availability for loaning the resource to the second entity.

At block 902, the system may enable the second entity to negotiate with the first entity for a loan of the resource. Enabling the second entity to negotiate with the first entity may include providing a communication channel between the first entity and the second entity. The communication channel may be established between processing devices adapted to communicate using a protocol defined for a peer-to-peer network provided by the marketplace. Enabling the second entity to negotiate with the first entity may include establishing a loan agreement using an e-commerce function of the marketplace.

In some examples, the system may provide the first entity with information identifying the second entity, and provide the first entity and the second entity with authentication information configured to enable secure communication between the first entity and the second entity.

In certain examples, the profile characterizes one or more business activities of the first entity based on one or more purchases made by the first entity in the marketplace. The resource may be a human resource, such as an employee skilled in a field of work related to the one or more purchases made by the first entity in the marketplace. The resource may include a tool used in relation to the one or more purchases made by the first entity in the marketplace. The resource may include a service provided in relation to the one or more purchases made by the first entity in the marketplace. The resource may include a physical space controlled by the first entity.

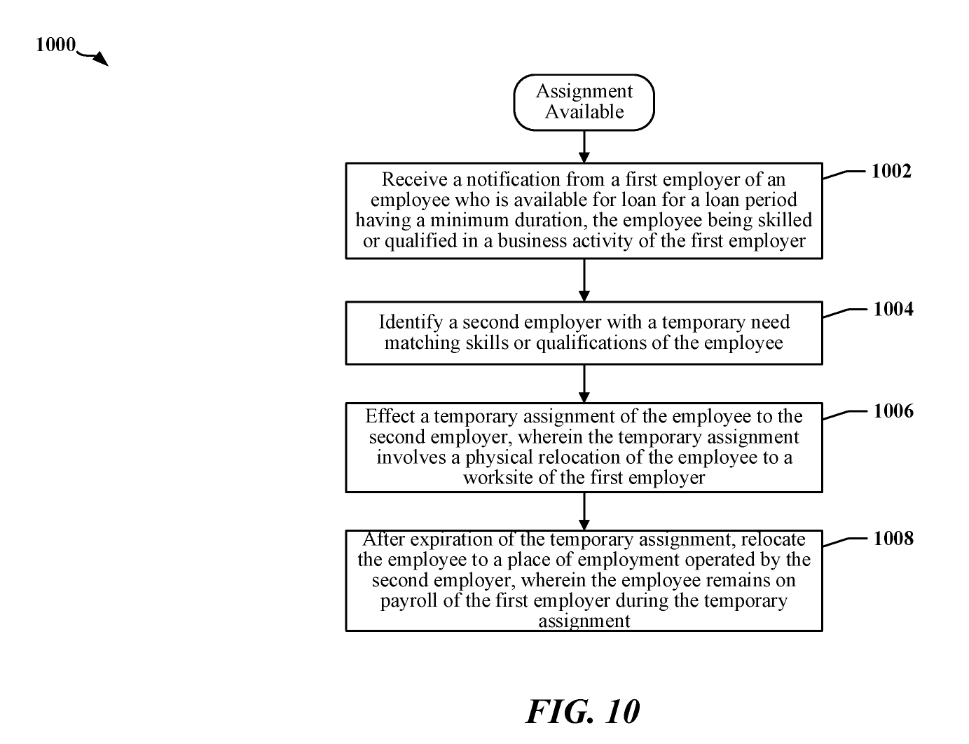

FIG. 10 is a flowchart illustrating a method for operating a virtual marketplace. At block 1002, the system may receive a notification from a first employer of an employee who is available for loan for a loan period having a minimum duration. The employee may be skilled or qualified in a business activity of the first employer. The employee may be vetted by the first employer.

At block 1004, the system may identify a second employer with a temporary need matching skills or qualifications of the employee. The first employer may be engaged in a same business activity as the second employer. The first employer and the second employer may be peers. The first employer and the second employer may be competitors. The first employer may instruct the employee regarding performance of business activities during the temporary assignment.

At block 1006, the system may effect a temporary assignment of the employee to the second employer. The temporary assignment may involve a physical relocation of the employee to a worksite of the first employer.

At block 1008, the system may relocate the employee to a place of employment operated by the second employer after expiration of the temporary assignment. The employee remains on payroll of the first employer during the temporary assignment.

In one example, the second employer may be identified by transmitting a message to a plurality of employers, receiving a response from at least the second employer, and transmitting a message to the first employer identifying the second employer.

In various examples, the system may maintain a profile of the employee in a database of candidate profiles. Each candidate profile may identify a skill set, a certification or an academic qualification of a corresponding candidate.

In some implementations, the system may send a notification to the employee, the notification identifying the second employer, and receive a response from employee accepting the temporary assignment.

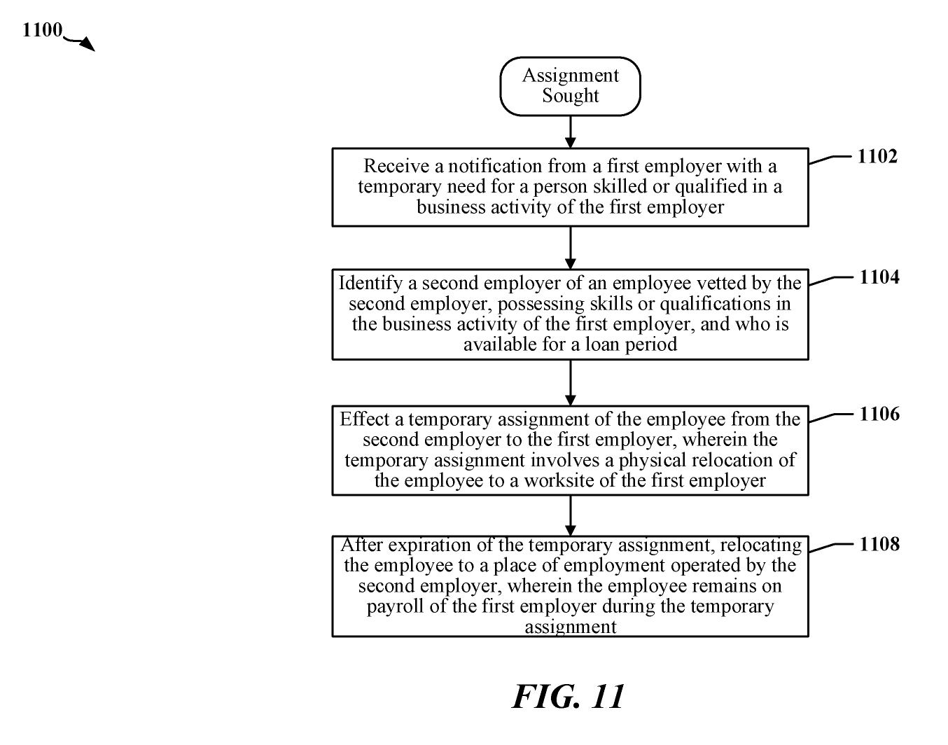

FIG. 11 is a flowchart illustrating a method for operating a virtual marketplace. At block 1102, the system may receive a notification from a first employer with a temporary need for a person skilled or qualified in a business activity of the first employer.

At block 1104, the system may identify a second employer of an employee vetted by the second employer. The employee may possess some or all of the skills or qualifications in the business activity of the first employer. The employee may be engaged in similar business activities while in the employ of the second employer. The employee may be temporarily idle or operating when business of the second employer is slow or below optimum activity levels. The employee may be vetted based on a background check, confirmation of credentials and/or qualifications. The employee may be available for a loan period corresponding with the temporary need of the first employer.

At block 1106, the system may effect a temporary assignment of the employee from the second employer to the first employer. The temporary assignment typically involves a physical relocation of the employee to a worksite of the first employer.

At block 1108, the system may initiate or cause relocation of the employee to a place of employment operated by the second employer after expiration of the temporary assignment. The employee may remain on the payroll of the first employer during the temporary assignment.

In one example, the first employer may be engaged in a same business activity as the second employer. The first employer and the second employer may be peers. The first employer and the second employer may be competitors. The second employer may instruct the employee regarding performance of business activities during the temporary assignment.

In some examples, identifying the second employer includes transmitting a message to a plurality of employers, receiving a response from at least the second employer, and transmitting a message to the first employer identifying the second employer.

In certain examples, the system may maintain a profile of the employee in a database of candidate profiles. Each candidate profile may identify a skill set, a certification or an academic qualification of a corresponding candidate. The system may identify the employee and/or the second employer based on one or more profiles.

In one example, the system may send a notification to the employee, the notification identifying the second employer, and receive a response from employee accepting the temporary assignment.

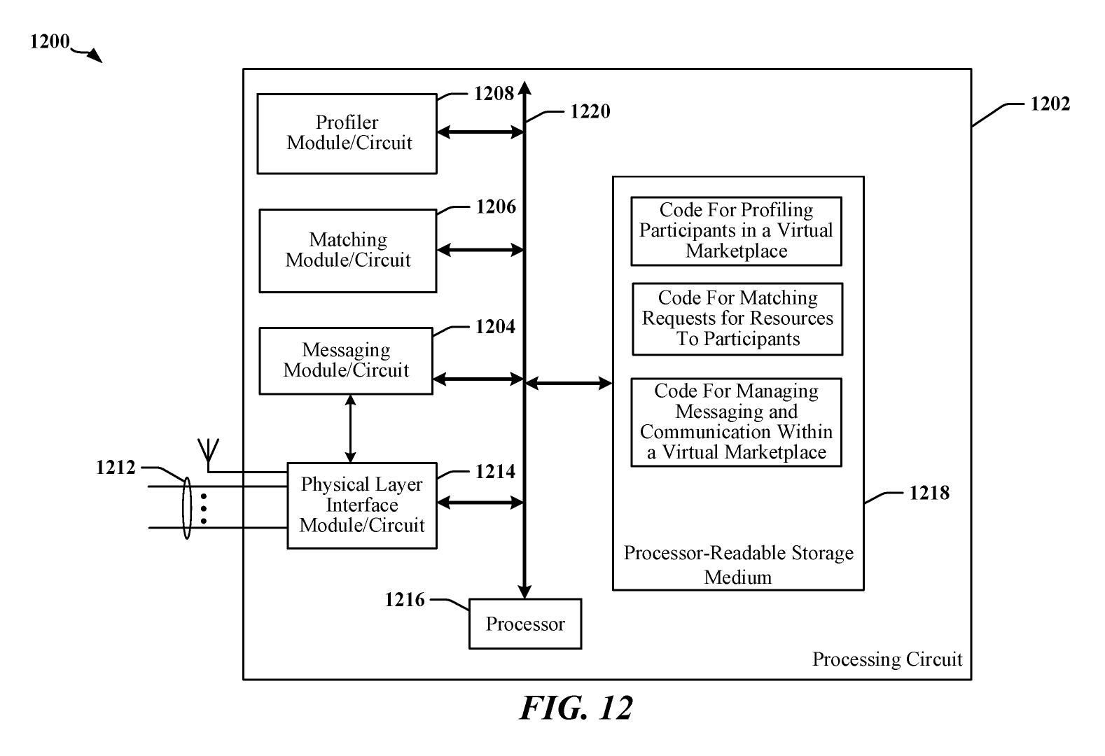

FIG. 12 is a conceptual diagram illustrating an example of a hardware implementation for an apparatus 1200 employing a processing circuit 1202. In this example, the processing circuit 1202 may be implemented with a bus architecture, represented generally by the bus 1220. The bus 1220 may include any number of interconnecting buses and bridges depending on the specific application of the processing circuit 1202 and the overall design constraints. The bus 1220 links together various circuits including one or more processors, represented generally by the processor 1216, and processor-readable media, represented generally by the processor-readable storage medium 1218, the modules or circuits 1204, 1206, and 1208, clock generating circuit 1210, line drivers 1212 coupled to the connectors or wires 1214 of the 3-wire bus and the processor-readable storage medium 1218. The bus 1220 may also link various other circuits such as timing sources, timers, peripherals, voltage regulators, and power management circuits. One or more additional clock generation circuits may be provided within the processing circuit 1202 or controlled by the processing circuit 1202 and/or one or more processors 1216. In one example, the clock generation circuits may include one or more crystal oscillators, one or more phase-locked loop devices, and/or one or more configurable clock trees. The clock generating circuits 1210 may include or be coupled to a multi-tap delay line.

The processor 1216 is responsible for managing the bus 1220 and general processing, including the execution of software stored on the processor-readable storage medium 1218. The software, when executed by the processor 1216, causes the processing circuit 1202 to perform the various functions described supra for any particular apparatus. The processor-readable storage medium 1218 may be used for storing data that is manipulated by the processor 1216 when executing software.

In one configuration, the processing circuit 1202 may include one or more modules and/or circuits 1208 configured to establish a profile for a first device that participates in a marketplace, one or more modules and/or circuits 1204 configured to receive a first message that a loan request for a resource from a computing device operated by a second entity, one or more modules and/or circuits 1206 configured to identify the first entity as a candidate for providing the resource based on the profile of the first entity, and one or more modules and/or circuits 1204 configured to exchange messages with plurality of entities involved in the loan.

Those of skill in the art would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method comprising:
establishing a profile on a profiler for a first entity that participates in a marketplace, wherein the profile characterizes one or more business activities of the first entity based on one or more transactions in the marketplace;
receiving a first message from a computing device operated by a second entity, wherein the message includes a loan request for a resource;
responsive to the request, identifying the first entity as a candidate for providing the resource based on the profile of the first entity when the first entity has no prior history of loaning the resource; and
enabling the second entity to negotiate with the first entity for a loan of the resource.

2. The method of claim 1, wherein identifying the first entity as a candidate for providing the resource comprises:
transmitting an unsolicited second message to a computing device operated by the first entity to determine availability for loaning the resource to the second entity.

3. The method of claim 2, and further comprising:
providing the first entity with information identifying the second entity; and
providing the first entity and the second entity with authentication information configured to enable secure communication between the first entity and the second entity.

4. The method of claim 1, wherein enabling the second entity to negotiate with the first entity comprises:
providing a communication channel between the first entity and the second entity.

5. The method of claim 4, wherein the communication channel is established between processing devices adapted to communicate using a protocol defined for a peer-to-peer network provided by the marketplace.

6. The method of claim 1, wherein enabling the second entity to negotiate with the first entity comprises:
establishing a loan agreement using an e-commerce function of the marketplace.

7. The method of claim 1, wherein the profile characterizes one or more business activities of the first entity based on one or more purchases made by the first entity in the marketplace.

8. The method of claim 7, wherein the resource comprises an employee skilled in a field of work related to the one or more purchases made by the first entity in the marketplace.

9. The method of claim 7, wherein the resource comprises a tool used in relation to the one or more purchases made by the first entity in the marketplace.

10. The method of claim 7, wherein the resource comprises a service provided in relation to the one or more purchases made by the first entity in the marketplace.

11. The method of claim 7, wherein the resource comprises a physical space controlled by the first entity.

12. The method of claim 11, wherein the physical space comprises a work space.

13. The method of claim 12, wherein the physical space comprises a conference room.

14. The method of claim 1, wherein a plurality of entities participates in the marketplace, wherein each of the plurality of entities is configured to operate as one or more of a seller, a buyer or an intermediary.

15. A method comprising:
receiving a notification from a first employer of an employee who is available for loan for a loan period having a minimum duration, the employee being skilled or qualified in a business activity of the first employer;
identifying a second employer with a temporary need matching skills or qualifications of the employee;
effecting a temporary assignment of the employee to the second employer, wherein the temporary assignment involves a physical relocation of the employee to a worksite of the second employer; and
after expiration of the temporary assignment, relocating the employee to a place of employment operated by the first employer,
wherein the employee remains on payroll of the first employer during the temporary assignment.

16. The method of claim 15, wherein the first employer is engaged in a same business activity as the second employer.

17. The method of claim 16, wherein the first employer instructs the employee regarding performance of business activities during the temporary assignment.

18. The method of claim 17, wherein identifying the second employer includes:
transmitting a message to a plurality of employers;
receiving a response from at least the second employer; and
transmitting a message to the first employer identifying the second employer.

19. The method of claim 15, wherein the employee is vetted by the first employer.

20. The method of claim 15, and further comprising:
maintaining a profile of the employee in a database of candidate profiles,
wherein each candidate profile identifies a skill set, a certification or an academic qualification of a corresponding candidate.

21. A method comprising:
receiving a notification from a first employer with a temporary need for a person skilled or qualified in a business activity of the first employer;
identifying a second employer of an employee vetted by the second employer, possessing skills or qualifications in the business activity of the first employer, and who is available for a loan period;
effecting a temporary assignment of the employee from the second employer to the first employer, wherein the temporary assignment involves a physical relocation of the employee to a worksite of the first employer; and
after expiration of the temporary assignment, relocating the employee to a place of employment operated by the second employer,
wherein the employee remains on payroll of the first employer during the temporary assignment.

22. The method of claim 21, wherein the first employer is engaged in a same business activity as the second employer.

23. The method of claim 21, wherein identifying the second employer includes:
transmitting a message to a plurality of employers;
receiving a response from at least the second employer; and
transmitting a message to the first employer identifying the second employer.

24. The method of claim 21, and further comprising:
maintaining a profile of the employee in a database of candidate profiles,
wherein each candidate profile identifies a skill set, a certification or an academic qualification of a corresponding candidate.

25. The method of claim 21, further comprising:
sending a notification to the employee, the notification identifying the second employer; and
receiving a response from employee accepting the temporary assignment.

26. The method of claim 21, wherein the second employer instructs the employee regarding performance of business activities during the temporary assignment.
